(19) United States
(12) Patent Application Publication
(10) Pub. No.: US 2018/0327090 A1
(43) Pub. Date: Nov. 15, 2018

(54) Drone with Distributed Electrical Storage

(71) Applicant: CHOUETTE, Saint-soupplets (FR)

(72) Inventors: Cyril De CHASSEY, Fontaine Chaalis (FR); Charles NESPOULOUS, Saint Cloud (FR)

(21) Appl. No.: 15/776,489

(22) PCT Filed: Nov. 18, 2016
(86) PCT No.: PCT/FR2016/053005

§ 371 Date: May 18, 2018

(30) Foreign Application Priority Data
Nov. 19, 2015 (FR) 1561161

(51) Int. Cl. B64C 39/02; A63H 27/00

(52) U.S. Cl. CPC B64C 39/024; A63H 27/12; B64C 2201/165; B64C 2201/042; B64C 2201/027

(57) ABSTRACT

Drone comprising a central body and a plurality of arms, preferably at least three arms, each arm comprising a first end mounted on the central body, each arm comprising, in the vicinity of a second end, at least one electric motor and at least one propeller coupled to said electric motor, each arm accommodating at least one electric battery.

### FIELD AND BACKGROUND OF THE INVENTION

The present invention relates to drones, meaning light unmanned aerial devices that are able to hover, particularly heavier-than-air propeller-driven machines.

In hover-capable drones, the most common configuration is the configuration with four propellers mounted on four respective arms, this configuration also being called “quadricopter”. However, there are also configurations with three propellers (“tricopter”), configurations with two propellers (“bicopter” or “twincopter”), and even configurations with one propeller having a rotating arm forming a wing; of course, there are also configurations with more than four propellers. All these configurations are covered by the present invention.

For the “quadricopter” configuration of reference, we know for example the configuration disclosed in document US20130068892. However, this type of device is relatively bulky and is not easy to transport. It has been proposed to be able to fold some elements of the drone into a transport configuration as disclosed in document US20150259066. However, even in the folded configuration, the size of the drone for transport is not optimal.

One will also note that the battery pack represents a significant volume, whether or not it is embedded in the body of the drone.

Finally, in an even more important aspect, known drones have a flight time that many users consider insufficient.

There is therefore a need to further optimize the architecture of drones, particularly in order to increase their autonomy in terms of flight time and also to facilitate their transport.

### BRIEF SUMMARY OF THE INVENTION

To this end, a drone is proposed here which comprises a central body and one or more arms, each arm comprising a first end mounted on the central body, each arm comprising at or near a second end at least one motor and at Least one propeller coupled to said motor, characterized in that each arm receives/houses (or even contains) at least one electrical energy storage device (typically a battery) between its first and second ends. This configuration is particularly relevant for drones comprising at least three arms (B1,B2,B3,B4).

One will note that at least one electrical energy storage device is housed in each arm.

With these arrangements, several advantages are obtained. First, the electrical energy storage is thus distributed, with good weight distribution. This also optimizes the moments of inertia involved in the roll, pitch, and yaw movements.

In addition, the size of the central body can be significantly reduced compared, to prior art drones, which is favorable from an aerodynamic point of view (reduced drag).

In other words, the electrical energy storage devices are integrated into the arms of the drone. This provides additional benefits concerning the mechanical architecture of the drone, which are detailed at the end of this description.

In addition, the various electrical energy storage devices (batteries for example) housed in the arms can advantageously be electrically connected in parallel, which reduces the current drawn from each of the batteries, particularly during spikes in current draw. In other words, the current drawn from each battery is much lower than the current drawn from a single central battery pack in the drones of the prior art. This improves the flight time which can be substantially increased as will be seen below.

Alternatively, each motor can be powered primarily by the battery which is housed in the arm to which said motor is attached, with no electrical connection between batteries. This eliminates the passage of substantial current, through the central body region, and reduces the general electromagnetic emissions during control.

In various embodiments of the invention, one or more of the following arrangements may possibly be used:
the electrical energy storage devices housed in the arms account for most of the electrical energy required for hovering and flight. It is thus possible to have a central body of small dimensions; however, this does not rule out the possible presence of an auxiliary battery in the central body.
each arm (Bi) is provided with an assembly (4i) of energy storage cells, said assemblies being electrically connected in parallel via the central body; this allows choosing battery cells of suitable power and moderate cost.
according to an alternative solution, each arm (Bi) is provided with an assembly (4i) of electrical energy storage cells which substantially powers the corresponding motor (Mi) attached at the end of the arm; each motor is thus primarily supplied by the closest assembly of battery cells, which reduces electromagnetic emissions;
each arm may have a cylindrical shape and comprise a tubular casing in which are housed one or more electrical energy storage devices of cylindrical shape; this represents an optimum shape for accommodating a maximum amount of electrical energy in an arm while remaining of reasonable diameter, and does not create excessive aerodynamic drag; in addition, this corresponds to a standard and common form of battery cells;
each arm is removably mounted on the body by means of a coupling and is configured to be detached from the central body, in particular for charging the electric batteries and/or transporting the drone in compact form;
the coupling may comprise a mechanical interface and an electrical interface preferably combined together; this enables: quick assembly and an equally quick disassembly for the combined mechanical and electrical coupling; the coupling movement may preferably include a simple translational movement, without excluding a bayonet-type rotational movement at the end of insertion;
the mechanical interface may comprise a system for angular alignment of the arm about its main axis of the arm (W1) with respect to a receiving housing provided in the central body; one can thus ensure that the propeller axes are coincident with the general axis of the drone;
for example the system for angular alignment may comprise a projecting pin on the first end of the arm, received in a corresponding groove in the receiving housing; this represents a very simple solution to implement;
the mechanical interface may comprise a locking device with a passive locking function (insertion toy angular indexing then translation and snap-fitting) and a quick release function; disassembly is thus very easy and very fast.
for each arm, the electrical energy storage device extends for a length LB from the propeller axis and more than 40% of the length LB is cooled by the air flow directly driven by the propeller at the end of the arm; this is advantageous compared to the standard configuration where the central battery pack is not cooled by the flow from the blades in an optimal manner;
as an option, a foot is provided at each second end of an arm. This contributes to the robustness during landing regardless of how it lands, which also allows housing image capture elements on the underside of the central body.
the body is provided with an image capture device in the form of a camera and/or video camera; the drone can thus collect images and/or videos during flight for real-time or delayed processing.
the image capture device is incorporated into the body and its lens is directed downwards; images and/or videos of the sites flown over by the drone can thus be captured;
the electrical energy storage devices may comprise rechargeable batteries and/or supercapacitors;
the drone may be formed as a quadricopter with four arms and four propellers; this represents a good architectural compromise between cost and simplicity of the control system.

### PRESENTATION OF FIGURES

Other features and advantages of the invention will be apparent from the following description of one of its embodiments, given by way of non-limiting example with reference to the accompanying drawings, in which:

FIG. 1 shows a perspective view of a drone according to the invention,

FIG. 2 shows a top view of the drone of FIG. 1 according to the invention, and

FIG. 3 shows a schematic view in elevation,

FIG. 4 shows a more detailed view of the mechanical and electrical interface between the body and an arm,

FIG. 5 shows an electrical diagram,

FIG. 6 shows a cross-section of the arm in its housing that is part of the central body,

FIG. 7 shows a recharging configuration for the arm subassemblies,

FIG. 8 shows an electric battery pack housed in one of the arms.

In the different figures, the same references denote identical or similar elements.

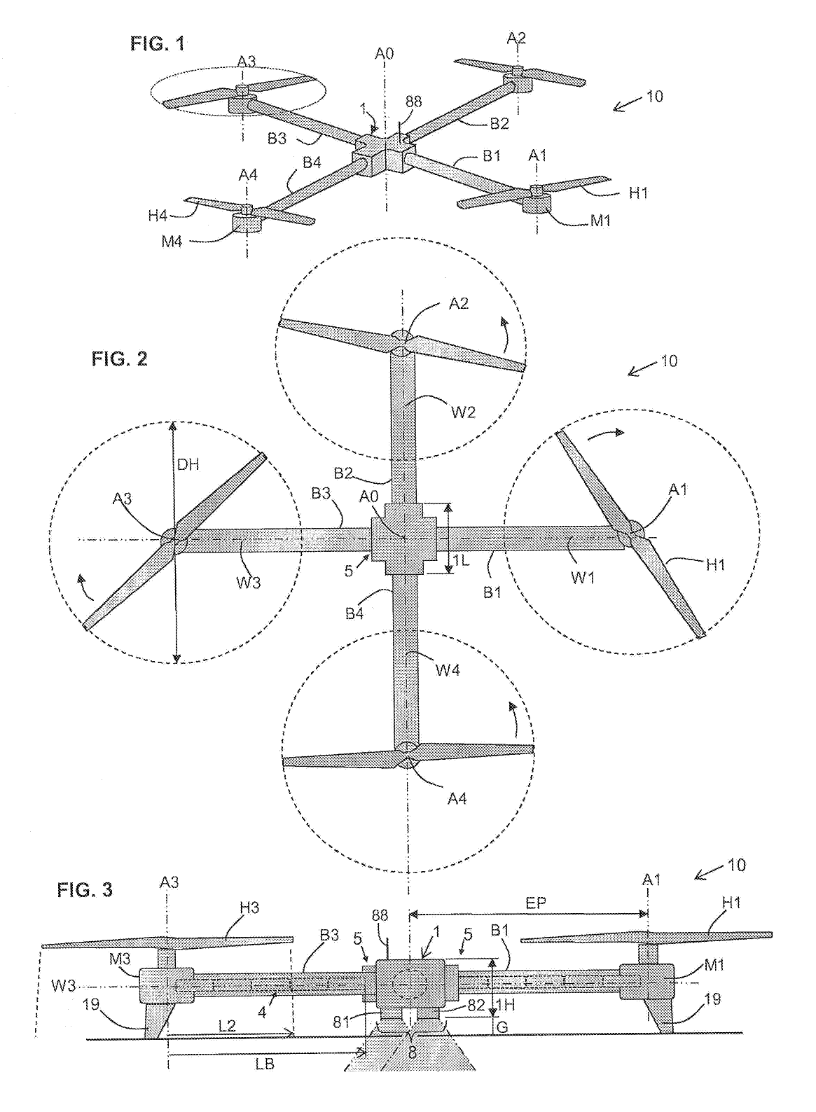

FIGS. 1 to 3 show a drone 10 according to an exemplary embodiment of the present invention. This is a conventional configuration with four propellers, each propeller being arranged at the end of an arm.

More specifically, the drone comprises a central body 1 which is located substantially at the center of the positions of the propellers and through which passes the general axis A0 of the drone. From the central body extend four arms 2 in a cross shape, respectively denoted B1 B2 B3 B4, generically denoted 2 or Bi (i being an index which here can be from 1 to 4).

At the end of each arm is attached a motor, the motors being respectively denoted M1 M2 M3 M4, generically denoted Mi, To the shaft of each motor is secured a propeller, the propellers being respectively denoted H1 H2 H3 H4. As is known per se, two propellers rotate in one direction and two in the other direction in order to substantially balance the resistive torques.

Each arm Bi comprises a first end 21 embedded in the central body and a second end 22, the respective motor Mi being attached at or near said second end.

Note that, instead of four arms, the drone in question could have three arms, five arms, six arras, or more than six arms; in other words the drone 10 has at least three arms.

Advantageously, each arm Bi houses at least one electrical energy storage and supply device (also referred to more briefly as “electrical energy storage device”). In the illustrated example, this is an electrical battery pack, referred to as “battery” for short; the batteries are respectively denoted 41 42 43 44 (generic notation 4i).

The battery 4i housed in an arm Bi is the main source of electric power for the motor Mi attached at the end of the arm. Specifically, battery B1 is the main source of electrical energy for motor M1, and so on for B2, M2, for B3, M3, and for B4, M4.

Thus, as illustrated here, there is no central battery attached to the central body of the drone. It is not excluded for there to be an electrical energy reserve connected to the central body 1, in particular for saving data in the electronic control unit for a reason that will be explained further below.

Preferably, most of the electrical energy required for hovering and flight is provided by batteries housed in the arms, and optionally the batteries housed in the arms provide all the electrical energy required for hovering and flight.

However, it is still possible to have a backup battery arranged in the central body. But in general, it is arranged so that the electric batteries housed in the arms represent more than 75% of the electrical energy available on board, preferably more than 90% of the electrical energy available on board.

In each arm, there is an assembly 4 of five battery cells 40 arranged one after the other, and these occupy most of the length of arm; said battery cells are electrically connected in serial mode by an arm harness 3 which will be detailed further below. Of course, instead of five cells, there may be less than five cells or more than five cells.

Note that for each arm, the battery cells occupy most of the length of the arm: in practice they extend along more than 85% of the length of the arm 2. Considered from another angle, they extend for more than 70% of the distance between A0-Ai.

According to one advantageous aspect, each arm Bx is removably mounted on the central body 1, meaning that the arm. can be uncoupled and the drone thus disassembled. After removal of the four arms, the drone is a set of five separate elements. Therefore, the drone can be arranged in a very compact form with the arms parallel to each other, and the central body having small dimensions (compared to the main, body of existing drones); one can then easily transport the drone.

In the example shown, for a blade diameter of 30 cm, the central body can be contained in a cube with sides of less than 10 cm.

Thus, as the dimensions of the central body are greatly reduced, it is possible to transport the disassembled drone in a small container such as a backpack.

More generally, for a blade diameter DH, the central body 1 can be contained within a cube of sides that are less than ⅓ of DH.

In particular, the height 1H of the central body will be less than 25% of DH and the horizontal width of the central body denoted 1L will be less than 40% of DH. The distance EP between the propeller axis and the main axis of the drone A0 will typically be between 0.7 DH and 1.5 DH.

One will note here that no limitation is placed on the shape of the central body in the horizontal plane: a cross shape as shown, an octagonal shape, a disk shape, etc. The casing 12 of the central body is preferably formed of a lightweight and resistant material, for example a high-performance plastic or a fiber-reinforced composite (glass or carbon).

In the example shown, the arms and the battery cells are cylindrical. The battery cells are housed in a tubular casing 25 which forms the supporting structure of the arm. The tubular casing may be formed of carbon fiber material.

The thickness of the casing 25, denoted E2, can be reduced to 1 or 0.5 mm for an outer diameter D2 of the arm of 2 to 4 cm.

Each arm is removably mounted on the body by means of a detachable coupling 5.

The coupling 5 comprises a mechanical interface and an electrical interface. The electrical interface is formed by a connection 7i with a connector 15 arranged at the first, end 21 of the arm and a counterpart connector 16 which faces it in the central body. When the arm is inserted into the receiving housing 11, the connector and its counterpart are coupled. Multiple electrical conductors use this connection, typically between 4 and 8 conductors. The conductors connected to the connector 15 form an arm harness 3, while in the central body, the conductors connected to the counterpart connector 16 are connected either to the main circuit board 60 where the electronic control unit 6 is located, or for some to a power busbar.

The mechanical interface comprises a system for angular alignment of the arm about its main axis of the arm W1 relative to a receiving housing 11 provided in the central body. In the current case, there is provided a projecting pin 27 on the first end of the arm, received in a corresponding groove 17 in the receiving housing 11,

In the illustrated example, where the drone is used to collect snapshots, an image capture device 8 is provided. More specifically, in the particular example illustrated, a first conventional image capture device 81 that operates in the visible range and a second image capture device 82 that operates in the infrared are provided.

In addition, as can be seen in FIG. 3, a foot 19 Is provided at the second end 22 of each arm. Sufficient ground clearance G Is provided so that during landing of the drone on a surface that is not perfectly flat, the lenses of the optical capture devices 81,82 do not touch and are not damaged.

We note in passing that it is not excluded to provide propeller fairings, such fairings being attached to the arm.

On the central body, an antenna 88 is provided for receiving signals transmitted by a remote control device that is known per se.

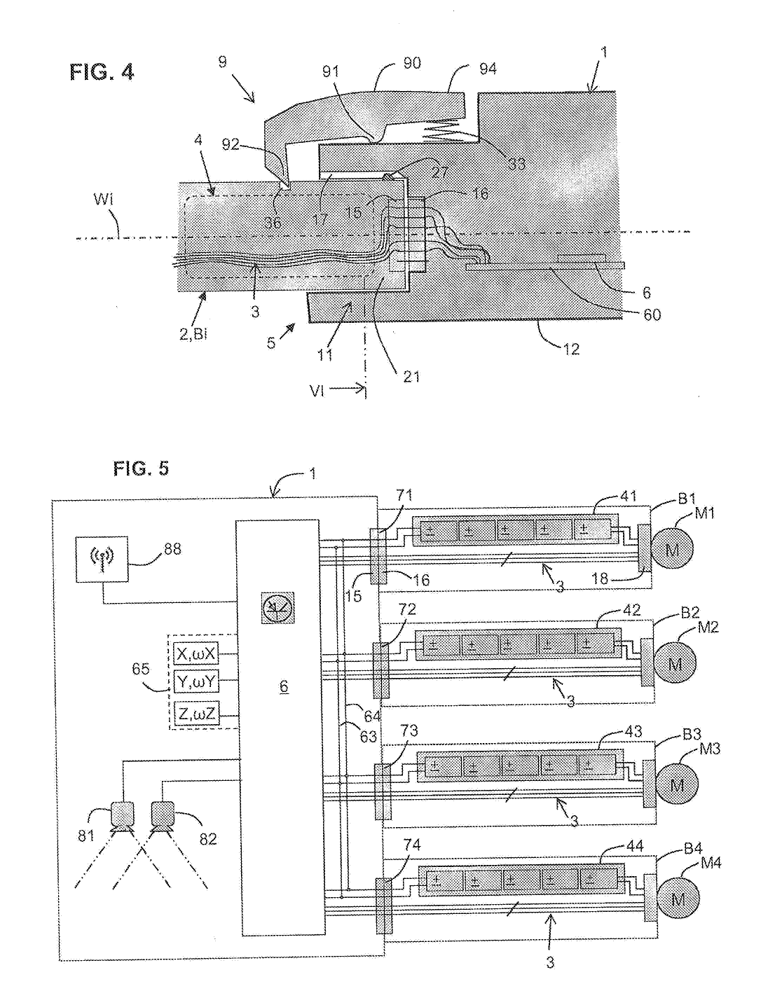

In the interface/coupling 5 shown in FIG. 4, a locking device 9 may be provided with a locking feature formed by a rocker arm 90 pivoting on a support 91. The rocker arm comprises a hook 92 which engages in a notch 36 formed in the tubular casing 25 of the arm. The rocker arm 90 is biased toward the locking position by a spring 33.

By pressing on the rear of the rocker arm 94, counter to the spring 33, one can release the lock and withdraw the arm along its axis W. In doing so, the electrical connector is uncoupled and the control signals emitted by the central processing unit can no longer reach the motor, which is a safety feature not provided by configurations which are simply folded.

It may optionally be provided, for each branch/arm Bi, that the electrical power conductors which connect the battery 4i to the motor Mi pass through the connector 7i such that uncoupling the connector cuts off not only the control signals but also the electrical connection between the battery and the motor Mi, which is an additional safety feature.

One should understand that the lock as presented above is not essential; a friction fit, a reversible snap-fit, or other retaining solution may be provided.

As illustrated in FIG. 5, one can see that local control electronics 18 near the motor receive control signals from the electronic central processing unit and switch the electrical power supplied by the local battery to control the motor according to dynamic real-time settings, for example in PWM cyclic modulation.

A controlling central processing unit 6 comprises one or more microprocessors, linear and/or angular accelerometers 65, mini-gyroscopes, wireless communication means, etc.

The electric power delivered by the battery cells to the motor is switched locally by the local control electronics 18. This reduces electromagnetic emissions from the power transitions.

In the illustrated configuration, where the four batteries are electrically connected in parallel, there is provided a positive busbar denoted 64 and a negative busbar denoted 63. During a spike in current draw by one of the motors, the four batteries contribute to providing the level of current required, which distributes the peak power requirements and therefore lightens the power-specifications for the batteries.

The connecting busbars 63,64 can be housed in the circuit board 60.

As illustrated in FIG. 7, once the arms are disassembled, the drone user can plug the outfitted arms 20 (in other words, arm Bi+motor Mi+propeller), also referred to as “arm assembly” 20, into a charging base 7. The charging base 7 comprises sockets 77 with a mechanical and electrical interface similar to the one already described for the central body.

The rechargeable battery cells used herein are lithium ion or lithium polymer, or supercapacitors (ultracapacitors) or any other equivalent technology available for storing electrical energy in an advantageous ratio of power to mass. The use of non-rechargeable batteries is not excluded.

Advantageously, one can choose to store electrical energy in battery cells having high technical and commercial availability, with the highest possible energy density: for example, a cylindrical shape having an outer diameter D4 between 1 and 3 centimeters and lengths between 5 and 8 centimeters.

The propellers illustrated have two blades. It is of course possible to have propellers with three blades or four blades; one could also have two propellers rotating in opposite directions, one above the other.

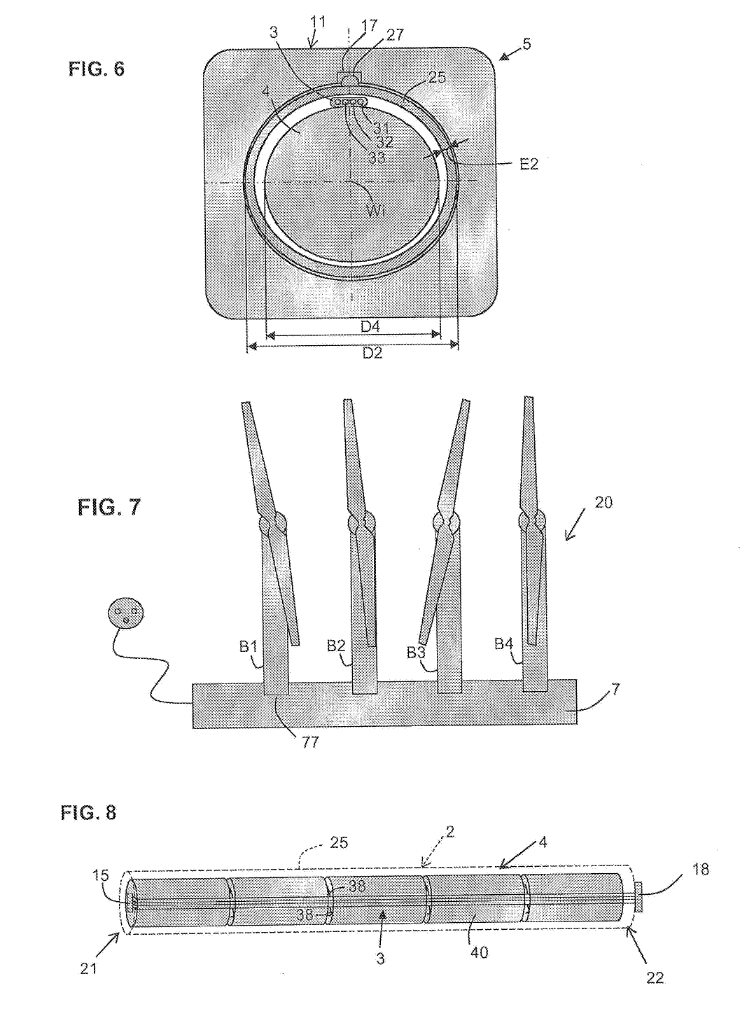

The arm harness 3 comprises multiple electrical conductors 31,32,33 that transmit torque/speed commands for the motor at the end of the arm. In addition, the harness 3 comprises serial connections 38 from one battery cell to another. One will note that the arm harness can be housed inside the structural casing 25 of the arm as shown in FIG. 6, but alternatively the arm harness 3 could run along the exterior of the structural casing.

As can be seen in FIG. 3, the air flow directly driven by the propeller Hi sweeps the arm over a radius L2 relative to the propeller axis, which is to be compared to the length denoted LB along which the energy storage cells extend. Advantageously, one can have the relation L2>0.4 LB. This provides optimal cooling of the batteries, particularly at their maximum power draw.

The drone 10: presented above can be used for monitoring crops, orchards, vineyards.

The flight time until recharging is greater than 30 minutes, preferably greater than 45 minutes, and can even reach 1 hour.

As stated earlier, the integration of batteries into the arms results in architectural optimization and reduced weight. Indeed, it puts to good use an arm structure which already must withstand the stresses related to the propeller, arid this structure serves as mechanical protection for the batteries. One can thus house bare batteries Inside the arms; conversely, no structure is required in the central body for attaching and/or protecting the batteries. This is in comparison to provisions of the prior art having a centralized battery pack which has its own mechanical protective casing and requires attachment to the central body.

1. A drone comprising a central body and one or more arms, each arm comprising a first end mounted on the central body, each arm comprising at or near a second end at least one motor and at least one propeller coupled to said motor, characterized in that at least one electrical energy storage device is housed in each arm between its first and second ends.

2. The drone according to claim 1, comprising at least three arms, and preferably four arms.

3. The drone according to claim 1, wherein the electrical energy storage devices housed in the arms account for most of the electrical energy required for hovering and flight.

4. The drone according to claim 1, wherein each arm is provided with an assembly of energy storage cells, said assemblies being electrically connected in parallel via the central body.

5. The drone according to claim 1, wherein each arm has a cylindrical shape and comprises a tubular casing in which are housed one or more electrical energy storage cells of cylindrical shape.

6. The drone according to claim 1, wherein each arm is removably mounted on the body by means of a coupling and is configured to he detached from the central body.

7. The drone according to claim 6, wherein the coupling comprises a mechanical interface and an electrical interface.

8. The drone according to claim 7, wherein the mechanical interface comprises a system for angular alignment of the arm about its main axis of the arm with respect to a receiving housing provided in the central body.

9. The drone according to claim 8, wherein the system for angular alignment is formed by a projecting pin on the first end of the arm, received in a corresponding groove in the receiving housing.

10. The drone according to claim 7, wherein the mechanical interface comprises a locking device with a passive locking function, namely insertion by translation with angular indexing and snap-fitting, and a quick release function.

11. The drone according to claim 1, wherein, for each arm, the electrical energy storage device extends for a length LB from the propeller axis and more than 40% of the length LB is cooled by the air flow directly driven by the propeller at the end of the arm.
